(19) United States
(12) Patent Application Publication
(10) Pub. No.: US 2009/0088104 A1
(43) Pub. Date: Apr. 2, 2009

(54) Method and System for Supporting a High-Speed Wireless Communication Platform

(75) Inventors: Shin-Shiuan Cheng, Tainan County (TW); Lin-Kai Bu, Tainan County (TW)

Correspondence Address: GENE I. SU, XIN YI RD., SECTION 4, NO. 151, 17F-1, TAIPEI, TW

(73) Assignee: HIMAX TECHNOLOGIES LIMITED, Tainan County (TW)

(21) Appl. No.: 11/862,209

(22) Filed: Sep. 27, 2007

(51) Int. Cl. H04B 7/00; H04B 1/02; H04N 5/00

(52) U.S. Cl. 455/130; 348/739; 455/91; 348/E05.001

(57) ABSTRACT

One embodiment of the present invention sets forth a wireless receiver device, which includes a receiver front-end configured to convert a transmitted radio-frequency signal into an intermediate signal and a backend processing unit coupled to the receiver front-end through a differential-type signaling interface and also configured to recover content from the intermediate signal from the receiver front-end.

### BACKGROUND OF THE INVENTION

1. Field of the Invention

The present invention generally relates to wireless technologies, and more particularly to a method and system for supporting a high-speed wireless communication platform.

2. Description of the Related Art

Unless otherwise indicated herein, the approaches described in this section are not prior art to the claims in this application and are not admitted to be prior art by inclusion in this section.

The wireless communication industry has seen significant growth over the past several years. An increasing number of consumer products, such as telephones, desktop and laptop computers, display devices, and personal digital assistants, include wireless communication capabilities. Some of this growth of wireless devices can be attributed to the introduction of standard-based wireless local area network (WLAN) products that are faster, lower in cost, and simpler to use. Examples of wireless standards applicable to WLAN products include the standard IEEE 802.11a that specifies radio transmission in the frequency band of 5 GHz (gigahertz) at speeds up to 54 Mbps (megabits per second) and IEEE 802.11b that specifies radio transmission in the frequency band of 2.4 GHz at speeds up to 11 Mbps.

As the demand for increasingly higher data transmission speeds continues to grow in the wireless space, a higher range of transmission frequency, such as in the order of tens of gigahertz and more particularly around 60 GHz, has been proposed to allow a wireless transmission speed in the order of gigabits per second. Because this frequency range offers a license-free bandwidth suitable for high data rate transmission, many applications in the fields of Personal Area Network (PAN) or High-Definition Multimedia Interface (HDMI) are thus being explored, such as wireless display, wireless docking station, and wireless streaming of uncompressed data from one device to another. However, propagating carrier waves at such high frequencies is not without certain constraints, including higher attenuation and the requirement of almost line-of-sight reception.

To illustrate how the requirement of line-of-sight reception may affect the wireless hardware implementation, FIG. 1 is a conceptual diagram showing the typical layout of a conventional standard-based wireless receiver device 100. The receiver device 100 includes a host device 102 that is coupled with a wireless adapter card 104 supporting wireless communication capabilities. The wireless adapter card 104 includes a radio-frequency (RF) receiver 106 connected to an antenna 108, an analog-to-digital converter 110, and a demodulator 112. A modulated RF signal is received via the antenna 108 and is then converted through the RF receiver 106 and the analog-to-digital converter 110 to an intermediate baseband signal. The demodulator 112 then processes the intermediate baseband signal to recover content, which is then further processed on the host device 102.

To achieve line-of-sight reception, the wireless adapter card 104 ideally has to be placed in a particular location and orientation in the receiver device 100 so that the antenna 108 is aligned with a transmitter device in a straight-line or in a near straight-line configuration. Unfortunately, due to the space limitations or the layout design restrictions in the receiver device 100, such a placement of the wireless adapter card 104 is often infeasible. To overcome this issue, one approach may be to use a stand-alone antenna, unlike the antenna 108 that is integrated with the wireless adapter card 104, which can be flexibly placed to meet the required reception configuration. However, the transmission of such high frequency signals from the stand-alone antenna to the RF receiver 106 may still be problematic, if the antenna is placed a certain distance away from the RF receiver 106.

What is needed in the art is thus a method and system that can cost effectively configure a wireless communication platform to accommodate high speed wireless transmissions and address at least the problems set forth above.

### SUMMARY OF THE INVENTION

The present application describes a method and system for a high-speed wireless communication platform. Specifically, one embodiment of the present invention sets forth a wireless receiver device, which includes a receiver front-end configured to convert a transmitted radio-frequency signal into an intermediate signal and a backend processing unit coupled to the receiver front-end through a differential-type signaling interface and also configured to recover content from the intermediate signal from the receiver front-end.

At least one advantage of the present invention disclosed herein is the ability to configure a wireless communication platform to include two physically distinct blocks, such as a transceiver front-end and a backend processing unit, that are linked via a differential-type signaling interface. By having the individual blocks and the noise-tolerant signaling interface, the transceiver front-end can be flexibly placed and oriented in a position for optimal signal reception/transmission.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram of a conventional wireless receiver device;

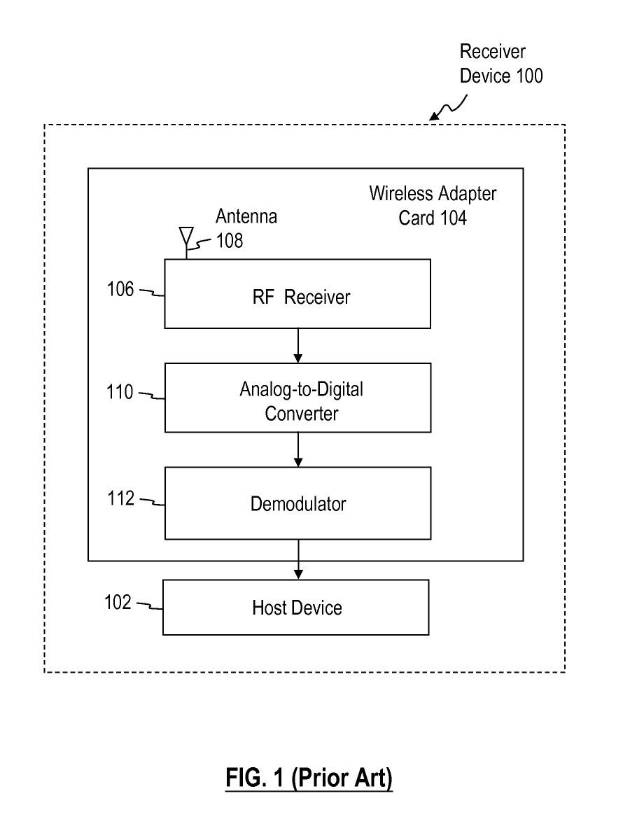

FIG. 2 is a simplified block diagram of a wireless receiver device, according to one or more aspects of the present invention;

FIG. 3 is a simplified block diagram of a wireless transmitter device, according to one embodiment of the invention;

FIG. 4 is a schematic view illustrating the configuration of a transceiver front-end and a backend processing unit in a wireless transceiver device according to one or more aspects of the present invention;

FIG. 5 is a flowchart showing the method steps for processing signals in a wireless receiver device, according to one embodiment of the present invention;

FIG. 6 is a flowchart showing the method steps for processing signals in a wireless transmitter device, according to one embodiment of the present invention;

FIG. 7 is a simplified block diagram of a wireless receiver device, according to an alternative embodiment of the invention; and

FIG. 8 is a simplified block diagram of a wireless transmitter device, according to one embodiment of the invention.

### DETAILED DESCRIPTION

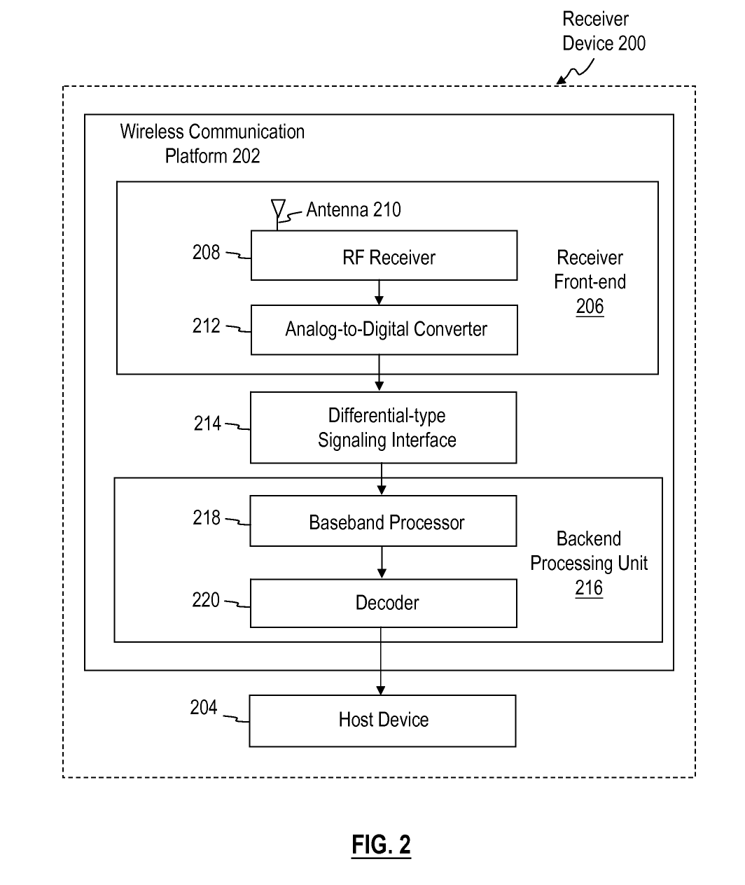

FIG. 2 is a simplified block diagram of a wireless receiver device 200, according to one embodiment of the present invention. The receiver device 200 includes a wireless communication adapter 202 that is coupled to a host device 204. The wireless communication platform 202, which includes a receiver front-end 206 that is coupled with a backend processing unit 216 via a differential-type signaling interface 214, receives, demodulates, and decodes a modulated signal transmitted in the air to recover content for presentation or for further processing on the host device 204. In the illustrated embodiment, one example of the modulated signal is a radio-frequency (RF) domain signal. However, in alternate embodiments, other frequency-domain signals may be used as carrier signals, such as infrared or microwave signals. Some examples of the host device 204 are, without limitation, a display device, a computer device, a personal digital assistant, a mobile phone, and any devices in general for which the installation of high speed wireless communication capabilities is desired. Further details of the wireless communication platform 202 are described below.

According to one embodiment of the present invention, the receiver front-end 206 and the backend processing unit 216 are configured as physically separate blocks that are linked via the differential-type signaling interface 214. More specifically, regarding the receiver front-end 206, a RF receiver 208, which is connected to an antenna 210, receives a modulated RF signal transmitted in the air and then processes the RF signal to allow desired information to be retrieved. The antenna 210 may be a stand-alone antenna or a patch antenna attached on an outer surface of the RF receiver 208 and/or the receiver front-end 206. Tasks handled by the RF receiver 208 includes translating the received RF signal to an intermediate signal, such as an analog signal with a low intermediate frequency (e.g., a baseband signal) and filtering unwanted interferences from the intermediate signal. The intermediate signal is then converted to a digitized form via an analog-to-digital converter 212. The output of the analog-to-digital converter 212 is connected to the differential-type signaling interface 214, through which the digitized form of the intermediate signal is transmitted to the backend processing unit 216 for further processing.

The differential-type signaling interface 214, which may include a low voltage differential signaling interface (“LVDS”), transmits the intermediate signal in the form of multiple electric signals, the difference of which encodes the information contained in the intermediate signal. The advantages associated with such a signaling interface include, without limitation, the ability to transmit along a longer signal path but still with low electromagnetic interferences and to support a high speed signaling rate. As a result, the receiver front-end 206 may be flexibly placed and oriented to receive RF signals transmitted in the air. For modulated RF signals that have a restrictive direction of propagation, such as RF signals in the range of tens of gigahertz or more, more flexibility thus are permitted to place the receiver front-end 206 for optimal signal reception.

Within the backend processing unit 216, a baseband processor 218 receives the intermediate signal transmitted from the receiver front-end 206 via the differential-type signaling interface 214. Tasks handled by the baseband processor 218 include, without limitation, demodulating the intermediate signal to reconstruct data frames, and/or retrieving access information from the data frames for transmission to the host device 204. As the information data might have been encoded in a compressed format, such as the MPEG4 format, the backend processing unit 216 may also include a decoder 220 adapted to restore the content from its encoded form. The restored content then is transmitted for presentation or for further processing on the host device 204.

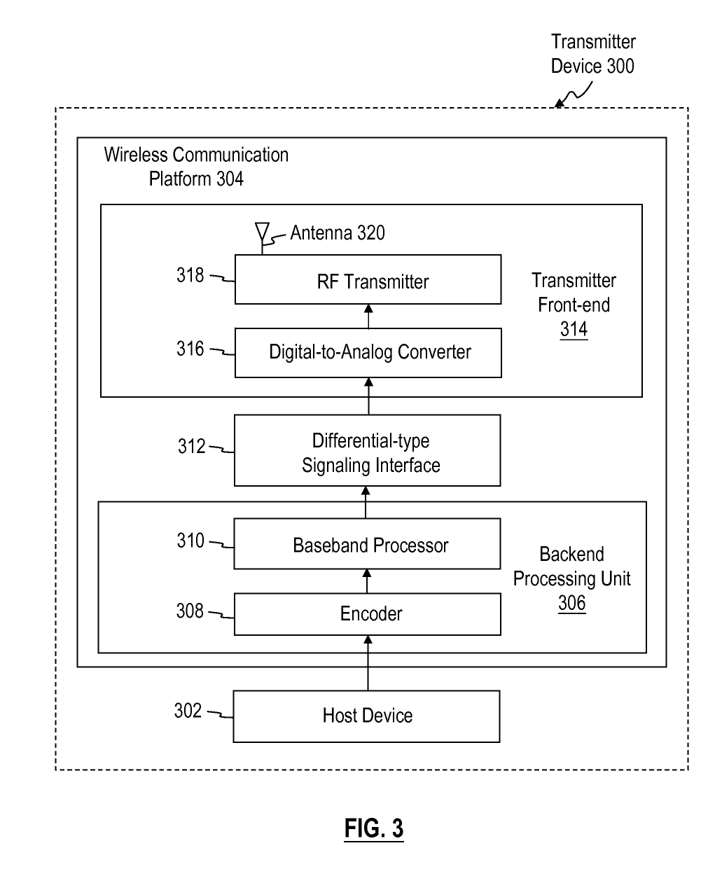

Also using a differential-type signaling interface, FIG. 3 is a simplified block diagram of a wireless transmitter device 300, according to one embodiment of the present invention. The transmitter device 300 includes a wireless communication platform 304 that is coupled to a host device 302. The host device 302 may include a display device, a computer device, a personal digital assistant, and in general any devices for which the installation of wireless communication capabilities is desired. Based on an information signal received from the host device 302, the wireless communication platform 304, which includes a backend processing unit 306 that is coupled with a transmitter front-end 314 via a differential-type signaling interface 312, modulates the information signal with an RF carrier signal to create a modulated signal and then transmits the modulated signal in the air.

According to one embodiment of the present invention, the transmitter front-end 314 and the backend processing unit 306 of the wireless communication platform 304 are configured as physically separate blocks that are linked via the differential-type signaling interface 312. More specifically, regarding the backend processing unit 306, an encoder 308 may be used to compress the information signal in an encoded format, such as the MPEG4 format, before it is processed through a baseband processor 310. Tasks handled by the baseband processor 310 include, without limitation, formatting the information signal into data frames, encapsulating access information in the data frames, and generating an intermediate signal based on the formatted information signal. The intermediate signal then is transmitted via the differential-type signaling interface 312, which may be an LVDS interface, to the transmitter front-end 314. In the transmitter front-end 314, the intermediate signal is converted to an analog form via a digital-to-analog converter 316, and is then processed via a RF transmitter 318 to generate a modulated RF signal that is transmitted in the air via an antenna 320. It should be apparent to a person with ordinary skills in the art that the receiver front-end 206 of FIG. 2 and the transmitter front-end 314, in one implementation, are parts of a transceiver component. Thus, a “transceiver” is capable of performing the functions of the transmitter and the receiver.

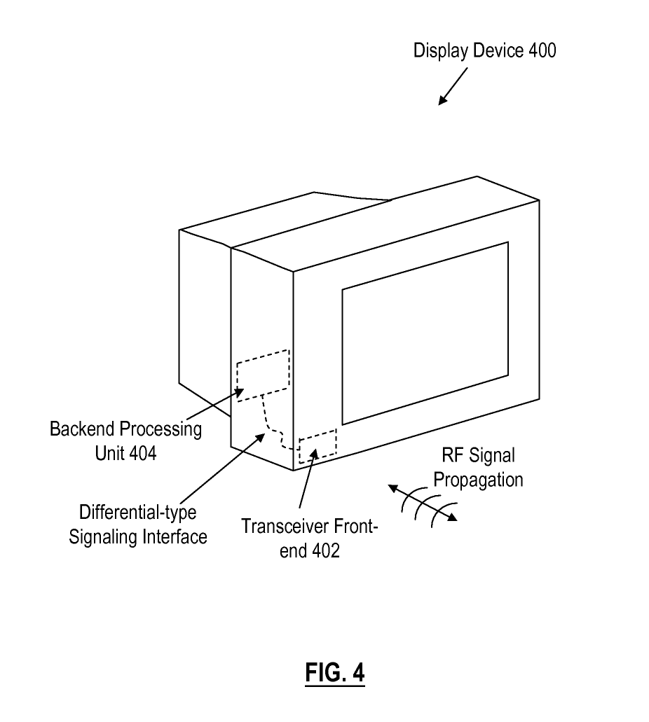

As discussed above, because the differential-type signaling interface is capable of transporting data on a longer signal path and at a very high speed, the design constraints typically imposed on a high-speed wireless communication adapter (e.g., requiring the transceiver front-end to be adjacent to the backend processing unit and often needing these components to be placed on the same adapter card) are alleviated if the differential-type signaling interface is utilized. As illustrated in a display device 400 supporting wireless capabilities in FIG. 4, a transceiver front-end 402 thus can be flexibly placed and oriented in a position for optimal reception/transmission of modulated RF signals. It is worth noting that the transceiver front-end 402 is not at all adjacent to a backend processing unit 404, and they reside on physically distinct adapter cards.

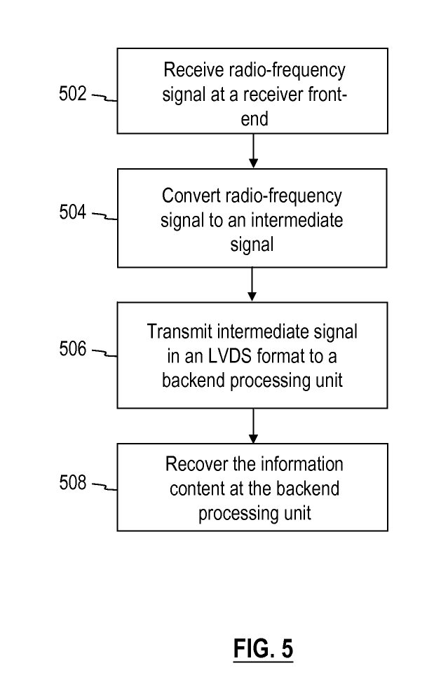

In conjunction with FIG. 2, FIG. 5 is a flowchart of method steps performed in the wireless receiver device 200 according to an embodiment of the invention. In initial step 502, a modulated RF signal is received by the receiver front-end 206. In step 504, the receiver front-end 206 converts the RF signal into an intermediate signal via the RF receiver 208 and the analog-to-digital converter 212. In step 506, the intermediate signal then is transmitted via the differential-type signaling interface 214, e.g., LVDS interface, to the backend processing unit 216. The intermediate signal then is respectively processed through the baseband processor 218 and decoder 220 to recover content for presentation or for further processing on the host device 204 in step 508.

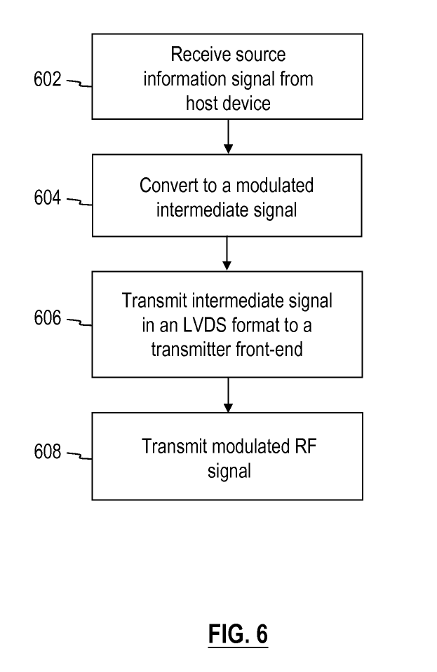

In conjunction with FIG. 3, FIG. 6 is a flowchart of method steps performed in the wireless transmitter device 300 according to an embodiment of the invention. In initial step 602, a source information signal is sent by the host device 302. In step 604, the encoder 308 and the baseband processor 310 then encode and process the source information signal to generate a modulated intermediate signal. In step 606, the intermediate signal then is transmitted through the differential-type signaling interface 312, such as an LVDS interface, to the transmitter front-end 314. The intermediate signal then is respectively processed through the digital-to-analog converter 316 and the RF transmitter 318 to be converted into a modulated RF signal that is transmitted via the antenna 320 in step 608.

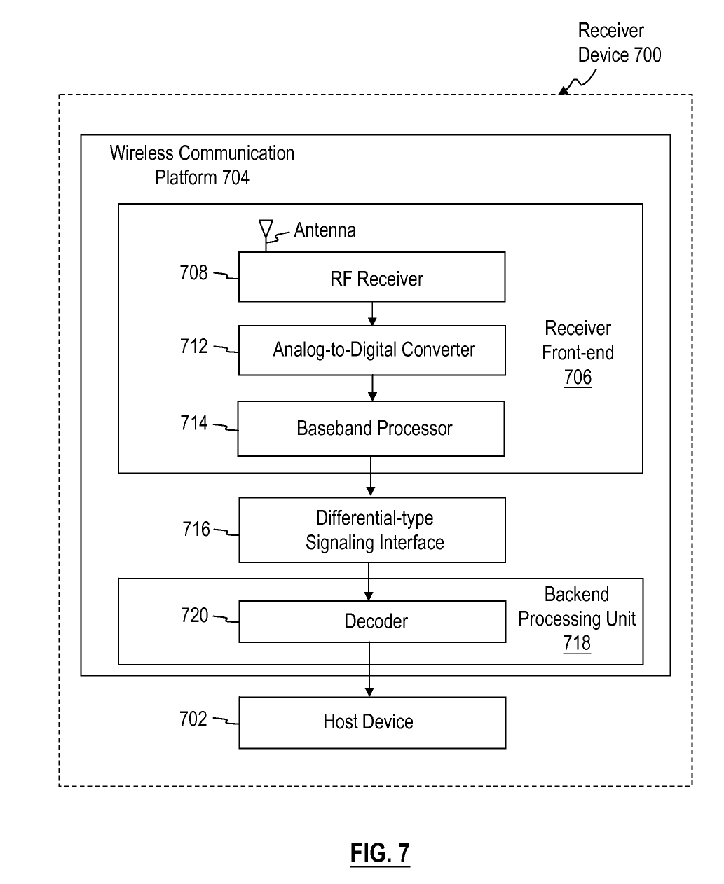

FIG. 7 is a simplified block diagram of a wireless receiver device 700 according to an alternative embodiment of the present invention. Like the embodiment of FIG. 2, the receiver device 700 includes a host device 702 coupled to a wireless communication platform 702, which also has a receiver front-end 706 linked to a backend processing unit 718 via a differential-type signaling interface 716. However, in addition to a RF receiver 708 and an analog-to-digital converter 712, the receiver front-end 706 also includes a baseband processor 714 that is configured to demodulate an intermediate signal provided from the RF receiver 708 and the analog-to-digital converter 712 to reconstruct data frames and/or retrieving access information from the data frames. The reconstructed data then are transmitted via the differential-type signaling interface 716 to the backend processing unit 718 to be decoded via a decoder 720, and are then sent to the host device 702.

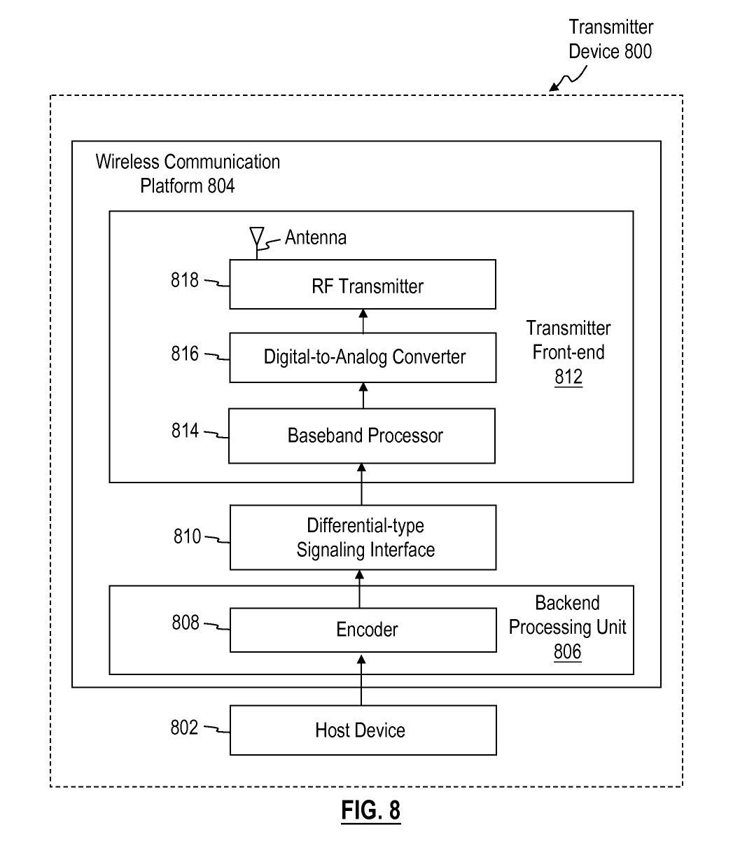

FIG. 8 is a simplified block diagram of a wireless transmitter device 800 according to an embodiment of the present invention. More specifically, the transmitter device 800 includes a wireless communication platform 804, which has a transmitter front-end 812 linked to a backend processing unit 806 via a differential-type signaling interface 810. The wireless communication platform 804 is coupled to a host device 802. However, in addition to a RF transmitter 818 and an analog-to-digital converter 816, the transmitter front-end 812 also includes a baseband processor 814. Based on an encoded signal provided by an encoder 808 in the backend processing unit 806 via the differential-type signaling interface 810, the baseband processor 814 generates an intermediate signal that is then converted to a modulated RF signal via the digital-to-analog converter 816 and the RF transmitter 818 for transmission via the antenna.

As has been described above, the method and system described herein thus is able to configure a wireless communication platform as two separate blocks, including a transceiver front-end and a backend processing unit linked via a differential-type signaling interface, so that the transceiver front-end can be flexibly placed and oriented in a position for optimal signal reception/transmission. While some specific layouts of the transceiver front-end and backend processing unit have been illustrated, other configurations may also be implemented without exceeding the scope of the present invention.

The above description illustrates various embodiments of the present invention along with examples of how aspects of the present invention may be implemented. The above examples, embodiments, instruction semantics, and drawings should not be deemed to be the only embodiments, and are presented to illustrate the flexibility and advantages of the present invention as defined by the following claims.

We claim:

1. A wireless receiver device, comprising:
a receiver front-end configured to convert a transmitted radio-frequency signal into an intermediate signal; and
a backend processing unit coupled to the receiver front-end through a differential-type signaling interface to recover content from the intermediate signal provided by the receiver front-end.

2. The wireless receiver device of claim 1, wherein the differential-type signaling interface includes a low voltage differential signaling interface.

3. The wireless receiver device of claim 1, wherein the backend processing unit includes a baseband processor and a decoder.

4. The wireless receiver device of claim 1, wherein the receiver front-end includes a radio-frequency receiver connected to an antenna, and an analog-to-digital converter.

5. The wireless receiver device of claim 4, wherein the receiver front-end further includes a baseband processor.

6. The wireless receiver device of claim 1, wherein the receiver front-end and the backend processing unit are configured as physically distinct blocks communicating with each other via the differential-type signaling interface.

7. The wireless receiver device of claim 1, wherein the radio-frequency signal is in the order of tens of gigahertz.

8. The wireless receiver device of claim 6, wherein the receiver front-end and the backend processing unit reside on distinct and non-adjacent adapter cards.

9. The wireless receiver device of claim 1, wherein the receiver front-end resides in a transceiver component that includes a transmitter front-end.

10. A wireless transmitter device comprising:
a backend processing unit configured to generate a modulated intermediate signal from an information source signal; and
a transmitter front-end coupled to the backend processing unit through a differential-type signaling interface for converting the intermediate signal to a radio-frequency signal.

11. The wireless transmitter device of claim 10, wherein the differential-type signaling interface includes a low voltage differential signaling interface.

12. The wireless transmitter device of claim 10, wherein the backend processing unit includes a baseband processor and an encoder.

13. The wireless transmitter device of claim 10, wherein the transmitter front-end includes a radio-frequency transmitter connected to an antenna and a digital-to-analog converter.

14. The wireless transmitter device of claim 13, wherein the transmitter front-end further includes a baseband processor.

15. The wireless transmitter device of claim 10, wherein the transmitter front-end and the backend processing unit are configured as physically distinct blocks communicating with each other via the differential-type signaling interface.

16. The wireless transmitter device of claim 10, wherein the radio-frequency signal is in the order of tens of gigahertz.

17. The wireless receiver device of claim 15, wherein the transmitter front-end and the backend processing unit reside on distinct and non-adjacent adapter cards.

18. The wireless receiver device of claim 10, wherein the transmitter front-end resides in a transceiver component that includes a receiver front-end.

19. A host device, comprising:
a display panel, coupled to a backend processing unit;
a transceiver front-end configured to convert a transmitted radio-frequency signal in the order of tens of gigahertz into an intermediate signal; and
the backend processing unit coupled to the transceiver front-end through a differential-type signaling interface to recover content from the intermediate signal provided by the transceiver front-end and to present the content on the display panel.

20. The host device of claim 19, wherein the transceiver front-end and the backend processing unit are configured as physically distinct and non-adjacent blocks communicating with each other via the differential-type signaling interface.
